(19) United States
(12) Patent Application Publication
(10) Pub. No.: US 2004/0209655 A1
(43) Pub. Date: Oct. 21, 2004

(54) Wireless equipment connection system

(76) Inventor: Yukihiro Kubo, Tokyo (JP)

Correspondence Address: BIRCH STEWART KOLASCH & BIRCH, PO BOX 747, FALLS CHURCH, VA, 22040-0747, US

(21) Appl. No.: 10/810,903

(22) Filed: Mar. 29, 2004

(30) Foreign Application Priority Data
Apr. 9, 2003 (JP) 2003-105491

(51) Int. Cl. H04B 7/00; H04Q 7/20; H04M 1/00; H04B 1/38

(52) U.S. Cl. 455/569.1; 455/41.2; 455/557; 455/569.2; 455/572; 455/573; 455/575.1

(57) ABSTRACT

A wireless equipment connection system includes a first terminal (1) provided with a first wireless connection interface (12) and a first control unit for starting the first wireless connection interface, and a second terminal (2) provided with a second wireless connection interface (22) and a second control unit (21) for starting the second wireless connection interface. The second terminal includes a holder (30) having a detector (31) for detecting whether or not the first terminal is set to the holder, and for outputting a set signal when detecting that the first terminal is set to the holder, and the second control unit of the second terminal starts the second wireless connection interface in response to the set signal sent from the detector, and establishes a wireless connection between the first terminal and the second terminal.

### BACKGROUND OF THE INVENTION

1. Field of the Invention

The present invention relates to a wireless equipment connection system that establishes a wireless connection between a vehicle-mounted information processor and a portable terminal device, and, more particularly, to a wireless equipment connection system that simplifies operations for wireless connections.

2. Description of Related Art

Conventionally, when using a mobile phone with handsfree within a car, for example, users can connect the mobile phone to a navigation device and talk over the mobile phone using both the communication function of the mobile phone and the voice-input/output function of the navigation device. There have been provided various methods of connecting a mobile phone to a navigation device.

Japanese patent application publication (TOKKAI) No. 2001-4387 discloses a navigation system that is a combination of a portable terminal unit, such as a mobile phone, and a vehicle-mounted information processor, such as a car navigation device. The portable terminal unit having a communication function is set to a cradle, and is connected with the vehicle-mounted information processor via either radio or an interface according to USB standards, RS232C standards, RS232E standards, or IEEE1394 standards so that the portable terminal unit and the vehicle-mounted information processor can communicate with each other. When the portable terminal unit is installed in a cradle, power is supplied from the vehicle-mounted information processor and a battery built in the portable terminal unit is charged.

However, when connecting the vehicle-mounted information processor to the portable terminal unit by radio, users need to perform a complicated operation in order to make it possible for those devices to acquire the address of the party on the other end of the connection and to perform timing acquisition for the start of the wireless connection.

Although what is necessary is just to always make the radio interfaces of both the devices into activation status in order to avoid this complicated operation, this results in a remarkable increase in the power consumption of the portable terminal unit and a reduction in the amount of use time of the portable terminal unit due to restrictions on the battery capacity of the portable terminal unit.

### SUMMARY OF THE INVENTION

The present invention is made to solve the above-mentioned problem, and it is therefore an object of the present invention to provide a wireless equipment connection system that can easily perform a wireless connection between two or more devices.

In accordance with the present invention, there is provided a wireless equipment connection system including a first terminal provided with a first wireless connection interface for performing short-distance wireless communications and a first control unit for starting the first wireless connection interface, and a second terminal provided with a second wireless connection interface for performing short-distance wireless communications and a second control unit for starting the second wireless connection interface, the second terminal including a holder having a detector for detecting whether or not the first terminal is set to the holder, and for outputting a set signal when detecting that the first terminal is set to the holder, and the second control unit of the second terminal starting the second wireless connection interface in response to the set signal sent thereto from the detector, and establishing a wireless connection between the first terminal and the second terminal.

As mentioned above, in accordance with the present invention, since the second wireless connection interface of the second terminal is started automatically and hence a wireless connection between the first terminal and the second terminal is established when the first terminal is set to the holder, users do not need to perform complicated operations in order to make the wireless equipment connection system establish the wireless connection. As a result, users can simply and quickly make the wireless equipment connection system establish a wireless connection between two or more devices.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of a wireless equipment connection system in accordance with embodiment 1 of the present invention;

FIG. 2 is a block diagram showing the structure of an example of the wireless equipment connection system in accordance with embodiment 1 of the present invention;

FIG. 3 is a sequence diagram showing a procedure of performing a handsfree call in the example of the wireless equipment connection system in accordance with embodiment 1 of the present invention;

FIG. 4 is a block diagram showing the structure of a wireless equipment connection system in accordance with embodiment 2 of the present invention;

FIG. 5 is a block diagram showing the structure of an example of the wireless equipment connection system in accordance with embodiment 2 of the present invention; and

FIG. 6 is a sequence diagram showing a procedure of performing a handsfree call in the example of the wireless equipment connection system in accordance with embodiment 2 of the present invention.

### DETAILED DESCRIPTION OF THE PREFERRED EMBODIMENTS

The preferred embodiments of the present invention will be now described with reference to the accompanying drawings. A wireless equipment connection system in accordance with the present invention will be explained by taking, as an example, a case where a portable terminal unit is used as a first terminal of the wireless equipment connection system and a vehicle-mounted information processor is used as a second terminal of the wireless equipment connection system. In the following description of the preferred embodiments, like reference numerals refer to like elements in the various views.

Embodiment 1.

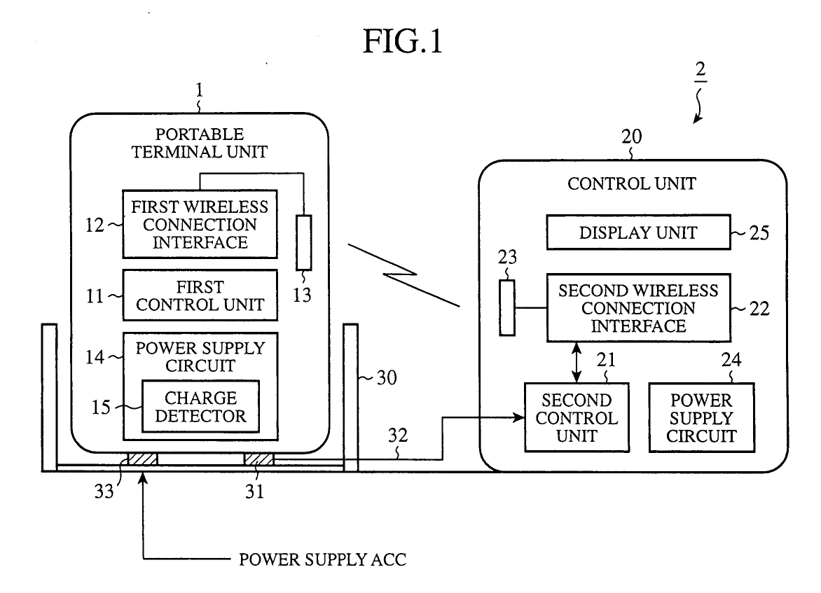

FIG. 1 is a block diagram showing the structure of a wireless equipment connection system in accordance with embodiment 1 of the present invention. This wireless equipment connection system comprises a portable terminal unit 1 and a vehicle-mounted information processor 2.

First, the portable terminal unit 1 will be explained. As the portable terminal unit 1, a mobile phone, a PDA (Personal Digital Assistant) or the like can be used. The portable terminal unit 1 has a short-distance wireless-communications function of carrying out wireless communications directly with the vehicle-mounted information processor 2 in addition to a mobile communications function of carrying out communications by using a mobile communications system offered by a telecom company.

The portable terminal unit 1 can carry out short-distance wireless communications by using Bluetooth, for example. Bluetooth is a portable information device-oriented wireless-communications technology for enabling communications at a rate of 1 Mbps among two or more devices that exist in a range of about 100 meters by using electric waves of a 2.4 GHz band.

The portable terminal unit 1 is provided with a first control unit 11, a first wireless connection interface 12, an antenna 13, and a power circuit 14. In FIG. 1, a configuration required for carrying out wireless communications using a general mobile communications system is not shown, and only a configuration required for short-distance wireless communications is shown.

The first control unit 11 comprises, for example, a microcomputer and controls the whole of the portable terminal unit 1. To this end, the first control unit 11 generates a start signal for starting the first wireless connection interface 12, for example.

The first wireless connection interface 12 is started in response to the start signal from the first control unit 11 and performs a process of carrying out wireless communications with the vehicle-mounted information processor 2. The first wireless connection interface 12 goes into sleep (pause) mode when placed in a state where no wireless connection between the portable terminal unit 1 and the vehicle-mounted information processors 2 is established. Thereby, the power consumption of the portable terminal unit 1 can be reduced.

The antenna 13 converts an electrical signal sent thereto from the first wireless connection interface 12 into an electric wave, and transmits it to the vehicle-mounted information processor 2. The antenna 13 receives an electric wave sent thereto from the vehicle-mounted information processor 2 and converts it into an electrical signal, and sends it to the first wireless connection interface 12.

The power circuit 14 supplies electric power outputted from a built-in battery, which is not illustrated in FIG. 1, to each of the components of the portable terminal unit 1. The power circuit 14 charges the built-in battery by using a power supply ACC supplied thereto from a holder 30 (mentioned later in detail) when the portable terminal unit 1 is set to the holder 30. The power circuit 14 is also provided with a charge detector 15. The charge detector 15 comprises, for example, a current detector, and detects whether a charging current from the holder 30 flows into the power circuit 14. The detection result obtained by the charge detector 15 is sent to the first control unit 11.

Next, the vehicle-mounted information processor 2 will be explained. The vehicle-mounted information processor 2 can consist of such a device as a car navigation device, a car audio device, a radio set, or a television set, or an apparatus into which some of them are integrated. The vehicle-mounted information processor 2 has a short-distance wireless-communications function of carrying out wireless communications directly with the portable terminal device 1. The vehicle-mounted information processor 2 can carry out short-distance wireless communications by using Bluetooth, for example.

The vehicle-mounted information processor 2 comprises a control unit 20 and the holder 30. The control unit 20 comprises a second control unit 21, a second wireless connection interface 22, an antenna 23, a power circuit 24, and a display 25. In FIG. 1, a structure implementing the original functions of the vehicle-mounted information processor 2 is not shown, and only a structure required for short-distance wireless communications is shown.

The second control unit 21 comprises, for example, a microcomputer and controls the whole of the vehicle-mounted information processor 2. To this end, the second control unit 21 generates a start signal for starting the second wireless connection interface 22, for example.

The second wireless connection interface 22 is started in response to the start signal from the second control unit 21 and performs a process of carrying out wireless communications with the portable terminal unit 1.

The antenna 23 converts an electrical signal sent thereto from the second wireless connection interface 22 into an electric wave, and transmits it to the portable terminal unit 1. The antenna 23 receives an electric wave sent thereto from the portable terminal unit 1 and converts it into an electrical signal, and sends it to the second wireless connection interface 22.

The power circuit 24 converts electric power having a high voltage outputted from a battery disposed in the vehicle, which is not shown in FIG. 1, into electric power having a predetermined voltage, and supplies it to each of the components of the vehicle-mounted information processor 2. The power circuit 24 supplies electric power for charging the built-in battery of the portable terminal unit 1 to the holder 30.

The display 25 displays the status of a current wireless connection and information about the portable terminal unit 1 with which the wireless connection is established. When the vehicle-mounted information processor 2 is a car audio device, the display 25 can display a selection of a piece of music, the status of the volume, etc. When the vehicle-mounted information processor 2 is a car navigation device, the display 25 can display a map, a route to a destination, traffic information, etc.

The holder 30 comprises a holding member for holding the portable terminal unit 1 which is called a cradle. The holder 30 can be formed apart from a housing of the vehicle-mounted information processor 2, or can be an integral part of the housing of the vehicle-mounted information processor 2. It is preferable that the holder 30 is placed so that no obstacle exists between the antenna 13 of the portable terminal unit 1 and the antenna 23 of the vehicle-mounted information processor 2 when the portable terminal unit 1 is set to the holder 30. When an obstacle cannot but exist because of restrictions on the structure of the vehicle-mounted information processor 2, it is preferable that a measure of providing a slit in the obstacle is taken so that transmission and reception of electric waves are easily carried out between the antenna 13 and the antenna 23.

The holder 30 is provided with a charge interface 33 for charging the built-in battery intended for both the detector 31 for detecting whether or not the portable terminal unit 1 is set to the holder 30, and the portable terminal unit 1. The detector 31 can consist of a machine-type microswitch, an optical sensor, or a pressure sensor, for example. The detection result obtained by the detector 31 is sent, as a set signal, to the second control unit 21 of the vehicle-mounted information processor 2 by way of a signal line 32.

The charge interface 33 is engaged into a power supply terminal (not shown) of the portable terminal unit 1, and supplies a power supply ACC to the power circuit 14. The power supply ACC is supplied from the power circuit 24 of the vehicle-mounted information processor 2, by way of wiring, to the power circuit 14, as mentioned above. As an alternative, the power supply ACC can be supplied from a cigar socket disposed in the vehicle, by way of a cable, to the power circuit 14.

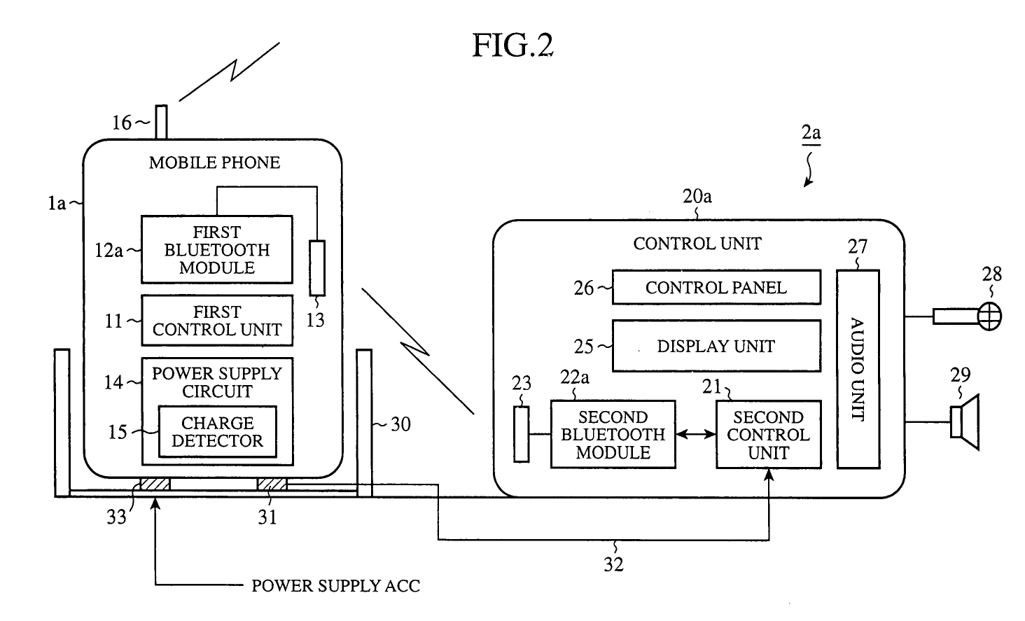

FIG. 2 is a block diagram showing the structure of an example of the wireless equipment connection system shown in FIG. 1 in which a mobile phone 1a is adopted as the portable terminal unit 1 and a car audio device 2a, such as a CD player, is adopted as the vehicle-mounted information processor 2, and users are allowed to make a phone call with handsfree by using the car audio device 2a. In the wireless equipment connection system shown in FIG. 2, the same components as those shown in FIG. 1 or like components are designated by the same reference numerals as shown in FIG. 1.

In addition to a general calling function, the mobile phone 1a has a short-distance wireless-communications function (referred to as a “Bluetooth function” from here on) using Bluetooth. In addition to a general audio function, the car audio device 2a has a Bluetooth function. The Bluetooth functions of the mobile phone 1a and the car audio device 2a can establish a wireless connection between them, and mobile-phone control commands, such as transmission-and-reception talk voices and dial data, are transmitted between them. Thereby, handsfree calls using a microphone 28 and a loudspeaker 29 can be made.

Concretely, the mobile phone 1a is equivalent to the one in which the antenna 16 is added to the portable terminal unit 1 as shown in FIG. 1.

In the mobile phone 1a, a first Bluetooth module 12a is used as the first wireless connection interface 12. The antenna 16 is used in order for the mobile phone 1a to make a general phone call or carry out communications by using a mobile communications system offered by a telecom company.

The car audio device 2a is equivalent to the one in which a control panel 26, an audio unit 27, the microphone 28, and the loudspeaker 29 are added to the vehicle-mounted information processor 2 as shown in FIG. 1. In the car audio device 2a, a second Bluetooth module 22a is used as the second wireless connection interface 22.

When using an audio function, users can use the control panel 26 in order to select a piece of music from a CD that is mounted to the car audio device 2a or to adjust the volume of the car audio device. The selection of a piece of music, the adjustment of the volume, etc. done through this control panel 26 are displayed on the display 25. Users can use the control panel 26 in order to use mobile-phone functions, such as a dialing function, a call originating function, and a call receiving function.

The audio unit 27 reproduces the piece of music selected through the control panel 26 by generating a musical-sound signal corresponding to the selected piece of music and sending it to the loudspeaker 29. In order to make a handsfree call, the audio unit 27 recognizes a voice inputted from the microphone 28, sends it to the second control unit 21, and also sends a sound signal sent from the second control unit 21 to the loudspeaker 29 so as to cause the loudspeaker 29 to make a voice.

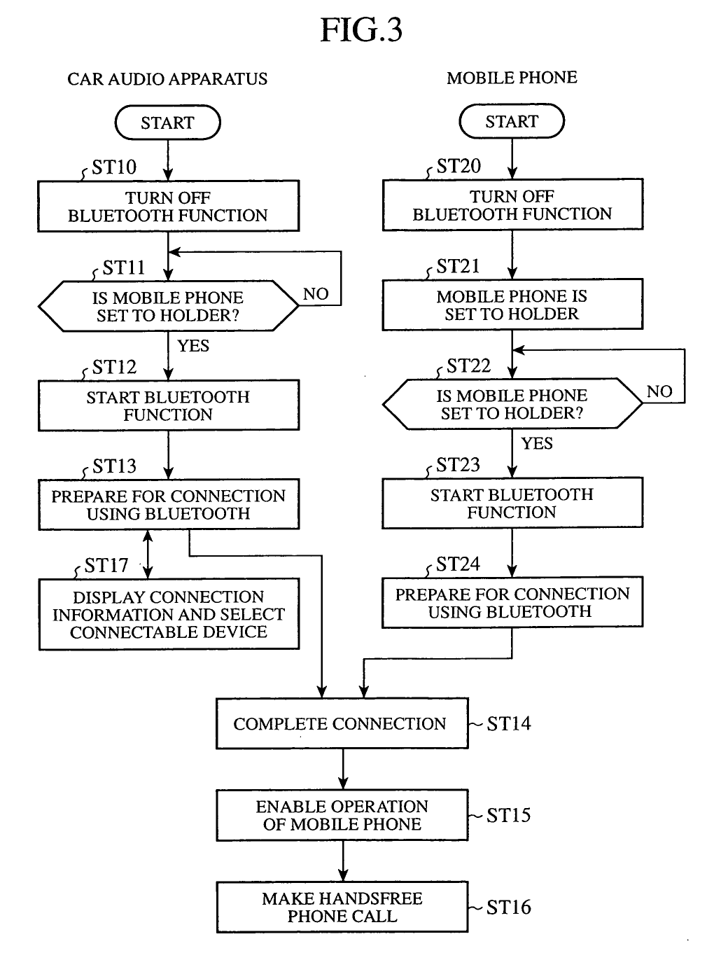

Next, by taking, as an example, a case where a handsfree call is made by the wireless equipment connection system shown in FIG. 2, the operation of the wireless equipment connection system in accordance with embodiment 1 of the present invention will be explained. FIG. 3 is a sequence diagram showing a procedure of making a handsfree call by the wireless equipment connection system as shown in FIG. 2.

In an initial state, the car audio device 2a turns off the Bluetooth function (in step ST10), and, after that, enters a standby state while checking to see whether or not the mobile phone 1a is set to the holder 30 (in step ST11). Concretely, the second control unit 21 of the car audio device 2a executes the loop of step ST11 while checking to see whether or not it has received a set signal indicating that the mobile phone 1a is set to the holder 30 from the detector 31 disposed in the holder 30.

On the other hand, the mobile phone 1a turns off the Bluetooth function (in step ST20), and, after that, enters a standby state while checking to see whether or not the mobile phone 1a itself is set to the holder 30 of the car audio device 2a (in step ST21). Concretely, the first control unit 11 of the mobile phone 1a executes the loop of step ST22 while checking to see whether the charge detector 15 disposed in the power circuit 14 detects a charging current flowing thereinto via the charge interface 33.

In this state, when the mobile phone 1a is set to the holder 30 (in step ST21), the detector 31 disposed in the holder 30 detects that the mobile phone 1a is set to the holder 30, and sends a set signal indicating that the mobile phone 1a is set to the holder 30 to the second control unit 21 of the control unit 20a via the signal line 32.

When receiving this set signal, the second control unit 21 sends a start signal to the second Bluetooth module 22a so as to start the Bluetooth function (in step ST12). Then, the mobile phone 1a starts preparing for a connection using Bluetooth (in step ST13).

On the other hand, when the mobile phone 1a is set to the holder 30 of the car audio device 2a in step ST22, a charging current flows into the power circuit 14 of the mobile phone 1a via the charge interface 33 and charge is started.

When detecting that a charging current flows into the power circuit 14 of the mobile phone 1a, the charge detector 15 disposed in the power circuit 14 sends a signal indicating that a charging current flows into the power circuit 14 to the first control unit 11. When receiving that signal from the charge detector 15, the first control unit 11 sends a start signal to the first Bluetooth module 12a so as to start the Bluetooth function (in step ST23). Then, the mobile phone 1a starts preparing for a connection using Bluetooth (in step ST24).

In the above-mentioned connection preparation of step ST13 and the connection preparation of step ST24, predetermined data are transmitted between the first Bluetooth module 12a and the second Bluetooth module 22a in accordance with a procedure that is predetermined between them, and negotiation for connection, such as searching of connectable devices and acquisition of Bluetooth device addresses BD-Addresses, is performed automatically.

The second control unit 21 of the car audio device 2a displays the connection state and the connection information about connectable devices, which are obtained through the above-mentioned negotiation by the second Bluetooth module 22a, on the display 25. For example, when two or more connectable devices are found out in the above-mentioned negotiation, the second control unit 21 displays a list of the devices on the display 25. Users can select one device with which they desire to establish a connection from the two or more devices displayed on the display 25 using the control panel 26, and can determine a communications partner (in step ST17).

When the negotiation is completed through the above-mentioned connection preparation of step ST13 and the above-mentioned connection preparation of step ST24, a connection between the car audio device 2a and the mobile phone 1a is completed and hence a wireless connection is established between them (in step ST14). Thereby, wireless communications using Bluetooth can be carried out between the car audio device 2a and the mobile phone 1a.

When the above-mentioned connection is completed, users are allowed to operate the mobile phone 1a by using the display 25 and control panel 26 of the car audio device 2a (in step ST15). In other words, users can dial the mobile phone 1a, make a phone call, and receive an incoming call. Users can make the wireless equipment connection system connect with a desired partner via the mobile phone 1a and a mobile communications system by dialing the mobile phone 1a using the display 25 and control panel 26 of the car audio device 2a in this state, and can make a handsfree call by using the microphone 28 and the loudspeaker (in step ST16).

As previously explained, the wireless equipment connection system in accordance with embodiment 1 of the present invention automatically starts the first Bluetooth module 12a of the mobile phone 1a when the mobile phone 1a is set to the holder 30 and the charge detector 15 detects a charging current flowing into the power circuit 14 of the mobile phone 1a, and, in response to a set signal from the holder 30, automatically starts the second Bluetooth module of the car audio device 2a so as to establish a wireless connection between the mobile phone 1a and the car audio device 2a. Therefore, users do not need to perform complicated operations to make the wireless equipment connection system establish a wireless connection using Bluetooth, and only have to set the mobile phone 1a to the holder 30. As a result, users can simply and quickly make the wireless equipment connection system establish a wireless connection between the car audio device 2a and the mobile phone 1a.

Embodiment 2.

Next, a wireless equipment connection system in accordance with embodiment 2 of the present invention will be explained. The wireless equipment connection system in accordance with this embodiment 2 is so constructed as to start a Bluetooth function of a portable terminal unit 1 according to a startup instruction from a vehicle-mounted information processor 2.

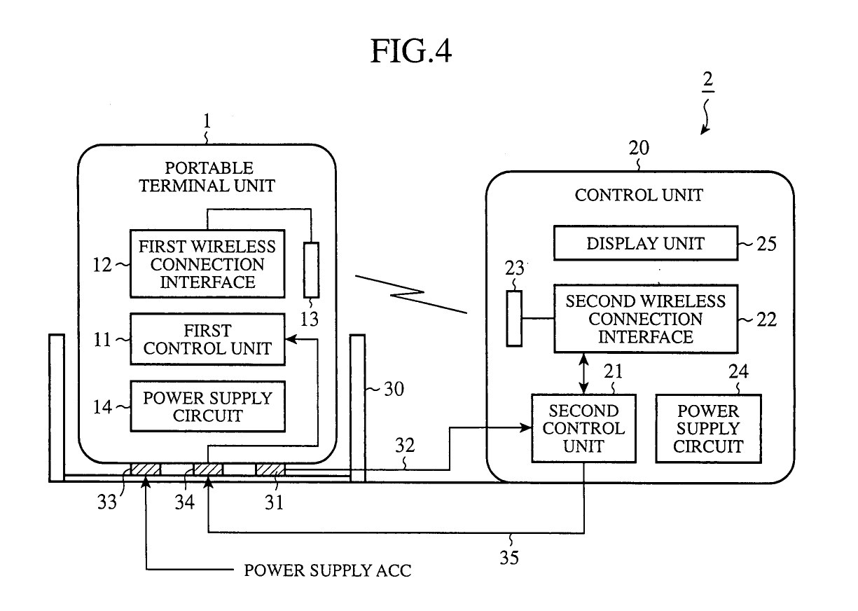

FIG. 4 is a block diagram showing the structure of the wireless equipment connection system in accordance with this embodiment 2. This wireless equipment connection system differs from the wireless equipment connection system in accordance with embodiment 1 in the following points.

In other words, a charge detector 15 is omitted from a power circuit 14 of the portable terminal unit 1, and the portable terminal unit 1 is constructed so that a startup instruction from an external interface 34 of a holder 30 is delivered to a first control unit 11.

The holder 30 of the vehicle-mounted information processor 2 is provided with the external interface 34, and a second control unit 21 of a control unit 20 is so constructed as to deliver the startup instruction to the external interface 34 via a signal line 35.

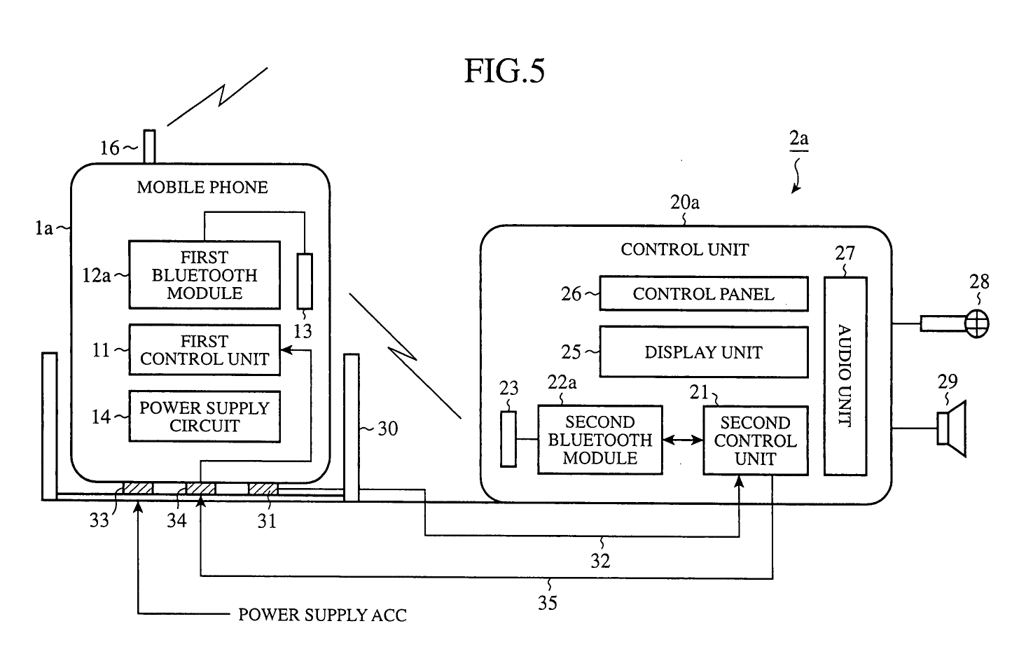

FIG. 5 is a block diagram showing the structure of an example of the wireless equipment connection system concerning embodiment 2 as shown in FIG. 4. The wireless equipment connection system differs from the example of the wireless equipment connection system in accordance with embodiment 1 in the following points.

In other words, the charge detector 15 is omitted from the power circuit 14 of a mobile phone 1a, and the mobile phone 1a is constructed so that a startup instruction from the external interface 34 of the holder 30 is delivered to the first control unit 11.

The holder 30 of a car audio device 2a is further provided with the external interface 34, and the second control unit 21 of the control unit 20a is so constructed as to deliver the startup instruction to the external interface 34 via the signal line 35.

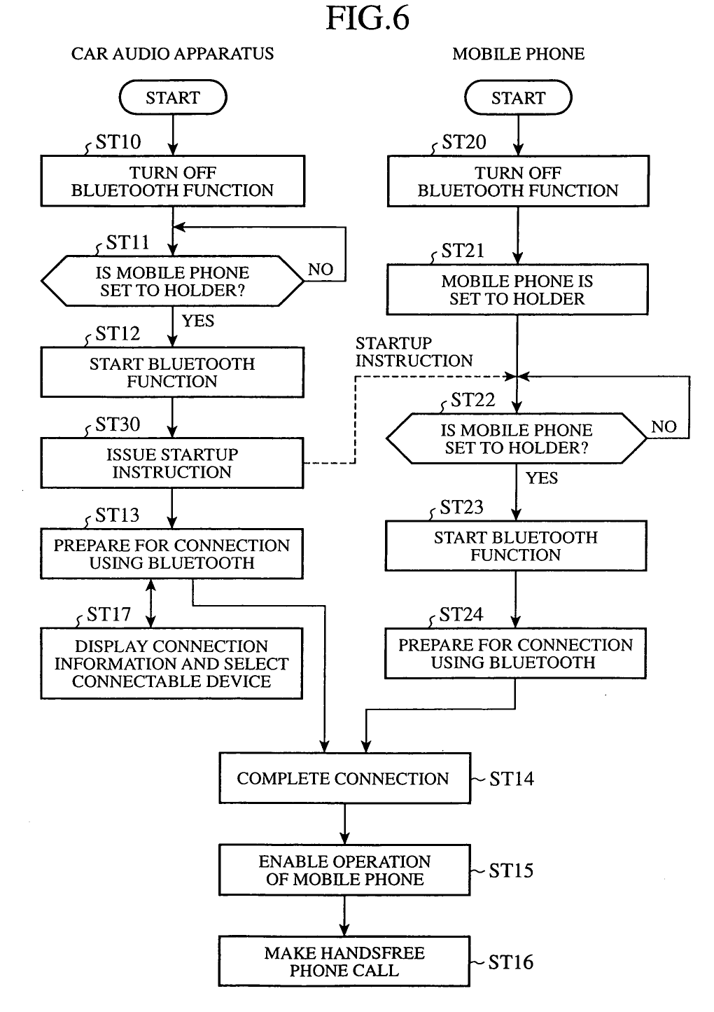

Next, by taking, as an example, a case where a handsfree call is made by the wireless equipment connection system shown in FIG. 5, the operation of the wireless equipment connection system in accordance with embodiment 2 of the present invention will be explained. FIG. 6 is a sequence diagram showing a procedure of making a handsfree call by the wireless equipment connection system as shown in FIG. 5. In FIG. 6, the same steps as those shown in FIG. 3 or like steps are designated by the same reference characters as shown in FIG. 3.

In an initial state, the car audio device 2a turns off the Bluetooth function (in step ST10), and, after that, enters a standby state while checking to see whether or not the mobile phone 1a is set to the holder 30 (in step ST11). Concretely, the second control unit 21 of the car audio device 2a executes the loop of step ST11 while checking to see whether or not it has received a set signal indicating that the mobile phone 1a is set to the holder 30 from the detector 31 disposed in the holder 30.

On the other hand, the mobile phone 1a turns of f the Bluetooth function (in step ST20), and, after that, enters a standby state while checking to see whether or not the mobile phone 1a itself is set to the holder 30 of the car audio device 2a (in step ST21). Concretely, the first control unit 11 of the mobile phone 1a executes the loop of step ST22 while checking to see whether it received a startup instruction from the second control unit 21 of the car audio device 2a via both the signal line 35 and the external interface 34.

In this state, when the mobile phone 1a is set to the holder 30 (in step ST21), the detector 31 disposed in the holder 30 detects that the mobile phone 1a is set to the holder 30, and sends a set signal indicating that the mobile phone 1a is set to the holder 30 to the second control unit 21 of the control unit 20a via the signal line 32. When receiving this set signal, the second control unit 21 sends a start signal to the second Bluetooth module 22a so as to start the Bluetooth function (in step ST12). The second control unit 21 then generates a startup instruction and sends it to the first control unit 11 of the mobile phone 1a via both the signal line 35 and the external interface 34 (in step ST30). Then, the mobile phone 1a starts preparing for a connection using Bluetooth (in step ST13).

On the other hand, when the car audio device 2a receives the startup instruction sent thereto in step ST30, the mobile phone 1a sends a start signal to the first Bluetooth module 12a so as to start the Bluetooth function (in step ST23). Then, the mobile phone 1a starts preparing for a connection using Bluetooth (in step ST24).

In the above-mentioned connection preparation of step ST13 and the connection preparation of step ST24, predetermined data are transmitted between the first Bluetooth module 12a and the second Bluetooth module 22a in accordance with a procedure that is predetermined between them, and negotiation for connection, such as searching of connectable devices and acquisition of Bluetooth device addresses BD-Addresses, is performed automatically.

The second control unit 21 of the car audio device 2a displays the connection state and the connection information about connectable devices, which are obtained through the above-mentioned negotiation by the second Bluetooth module 22a, on the display 25. For example, when two or more connectable devices are found out in the above-mentioned negotiation, the second control unit 21 displays a list of the devices on the display 25. Users can select one device with which they desire to establish a connection from the two or more devices displayed on the display 25 using the control panel 26, and can determine a communications partner (in step ST17).

When the negotiation is completed through the above-mentioned connection preparation of step ST13 and the above-mentioned connection preparation of step ST24, a connection between the car audio device 2a and the mobile phone 1a is completed and hence a wireless connection is established between them (in step ST14). Thereby, wireless communications using Bluetooth can be carried out between the car audio device 2a and the mobile phone 1a.

When the above-mentioned connection is completed, users are allowed to operate the mobile phone 1a by using the display 25 and control panel 26 of the car audio device 2a (in step ST15). In other words, users can dial the mobile phone 1a, make a phone call, and receive an incoming call. Users can make the wireless equipment connection system connect with a desired partner via the mobile phone 1a and a mobile communications system by dialing the mobile phone 1a using the display 25 and control panel 26 of the car audio device 2a in this state, and can make a handsfree call by using the microphone 28 and the loudspeaker (in step ST16).

As previously explained, the wireless equipment connection system in accordance with embodiment 2 of the present invention receives a start instruction from the car audio device 2a and automatically starts the first Bluetooth module 12a of the mobile phone 1a when the mobile phone 1a is set to the holder 30, and, in response to a set signal from the holder 30, automatically starts the second Bluetooth module of the car audio device 2a so as to establish a wireless connection between the mobile phone 1a and the car audio device 2a. Therefore, users do not need to perform complicated operations to make the wireless equipment connection system establish a wireless connection using Bluetooth, and only have to set the mobile phone 1a to the holder 30. As a result, users can simply and quickly make the wireless equipment connection system establish a wireless connection between the car audio device 2a and the mobile phone 1a.

Many widely different embodiments of the present invention may be constructed without departing from the spirit and scope of the present invention. It should be understood that the present invention is not limited to the specific embodiments described in the specification, except as defined in the appended claims.

What is claimed is:

1. A wireless equipment connection system comprising:
a first terminal provided with a first wireless connection interface for performing short-distance wireless communications and a first control unit for starting said first wireless connection interface; and
a second terminal provided with a second wireless connection interface for performing short-distance wireless communications and a second control unit for starting said second wireless connection interface, wherein said second terminal includes a holder having a detector for detecting whether or not said first terminal is set to said holder, and for outputting a set signal when detecting that said first terminal is set to said holder, and said second control unit of said second terminal starts said second wireless connection interface in response to the set signal sent thereto from said detector, and establishes a wireless connection between said first terminal and said second terminal.

2. The wireless equipment connection system according to claim 1, wherein said holder includes a charge interface for supplying a charging current to said first terminal when said first terminal is set to said holder, said first terminal includes a charge detector for detecting whether or not the charging current is supplied thereto from said holder, and said first control unit of said first terminal starts said first wireless connection interface when said charge detector detects that the charging current is supplied to said first terminal so as to establish a wireless connection between said first terminal and said second terminal.

3. The wireless equipment connection system according to claim 1, wherein said second control unit of said second terminal sends a start signal to said first control unit of said first terminal in response to the set signal sent thereto from said detector, and said first control unit of said first terminal starts said first wireless connection interface in response to the start signal sent thereto from said second terminal, and establishes a wireless connection between said first terminal and said second terminal.

4. The wireless equipment connection system according to claim 2, wherein said first and second wireless connection interfaces perform short-distance wireless communications by using Bluetooth.

5. The wireless equipment connection system according to claim 3, wherein said first and second wireless connection interfaces perform short-distance wireless communications by using Bluetooth.
